(19) United States
(12) Patent Application Publication
(10) Pub. No.: US 2008/0141351 A1
(43) Pub. Date: Jun. 12, 2008

(54) LOGIN PROCEDURE USING IMAGE CODE

(75) Inventor: Ji Yong Park, Gyeonggi-do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/945,175

(22) Filed: Nov. 26, 2007

(30) Foreign Application Priority Data
Nov. 27, 2006 (KR) 10-2006-0117564

(51) Int. Cl. G06F 21/00

(52) U.S. Cl. 726/5

(57) ABSTRACT

A method of generating an image code includes receiving a site identification (ID) of an access site, receiving a user ID and a password for accessing the access site, and generating an image code for establishing a login to the access site based upon the user ID and the password.

### CROSS REFERENCE TO RELATED APPLICATIONS

Pursuant to 35 U.S.C. § 119(a), this application claims the benefit of earlier filing date and right of priority to Korean Application No. 10-2006-0117564, filed on Nov. 27, 2006, the contents of which are hereby incorporated by reference herein in their entirety.

### FIELD OF THE INVENTION

The present invention relates to a login procedure using an image code.

### DISCUSSION OF RELATED ART

In general, image codes include a one-dimensional barcode, a two-dimension barcode, a two-dimensional matrix code, and the like. For example, the image codes are attached to products to be used in sales or distributions.

The image codes are encoded by an encoding module. After desired information is input by a user, the encoding module is executed to generate an image code having an image format. The image code can contain contents of several tens of Kbytes.

However, the image codes provide limited functions since the image code are generated by product manufacturers or marketers for their own purpose, for example, for recognizing information of the products.

### SUMMARY OF THE INVENTION

Features and advantages of the present invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In one general aspect, a method of generating an image code includes receiving a site identification (ID) of an access site, receiving a user ID and a password for accessing the access site, and generating an image code for establishing a login to the access site based upon the user ID and the password.

In the method of generating the image code, the image code may include one or more pieces of information relating to the access site. The site ID of the access site may be a portion or all of a website address. The login may be a login through an initial screen and a login when booting an operating system. The login may also be a login when returning from a standby screen to a previous user screen.

In another aspect, a method for performing login using an image code includes connecting to a site to which access requires a login, obtaining an image code via a camera, obtaining information from the image code, identifying in the information a site identification (ID) corresponding to the site, and initiating a login to the site based on a user ID and password included in the image code and which correspond to the site ID.

In the login method using the image code, the image code may be one or more pieces of information relating to the access site. The login may be a login through an initial screen. The login may also be a login when booting an operating system and a login when a terminal returns from a standby screen to a previous user screen. The login may also be a login through an image code agent installed in the terminal. The site ID may be a portion or all of a website address.

In yet another aspect, a terminal for login using an image code includes an image code generator for generating an image code for a login, an image code recognition device for obtaining information from the image code, and a controller for identifying in the information a site identification (ID) corresponding to a site, and if the site ID is identified, initiating a login to the site based on a user ID and password included in the image code and which correspond to the site ID.

In the terminal for login using the image code, the site ID may be a portion or all of a website address. The login may be a login through an initial screen. The login may also be a login when booting an operation system and a login when returning from a standby screen to a previous user screen.

In yet another aspect, a terminal for generating an image code includes means for receiving a site ID of an access site, means for receiving a user identification (ID) and a password for accessing the access site, and means for generating an image code for establishing a login to the access site based upon the user ID and the password.

It is to be understood that both the foregoing general description and the following detailed description of the present invention are exemplary and explanatory and are intended to provide further explanation of the invention as claimed.

### BRIEF DESCRIPTION OF THE DRAWINGS

Embodiments of the present invention are herein described in detail with reference to the following drawings in which like numerals refer to like elements.

The above and other aspects, features, and advantages of the present invention will become more apparent upon consideration of the following description of preferred embodiments, taken in conjunction with the accompanying drawing figures.

FIG. 1 is a block diagram showing a mobile terminal according to an embodiment of the present invention.

FIG. 2 is a flowchart illustrating a process of generating an image code during a login according to another embodiment of the present invention.

FIG. 3 is a flowchart illustrating a process of recognizing an image using an image code according to yet another embodiment of the present invention.

FIG. 4A illustrates an example of a display in which a website address is requested and received in a process of generating an image code.

FIG. 4B illustrates an example of a display in which an ID and password are requested and received in a process of generating an image code.

FIG. 4C illustrates an example of a display in which an ID and password are added in a process of generating an image code.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

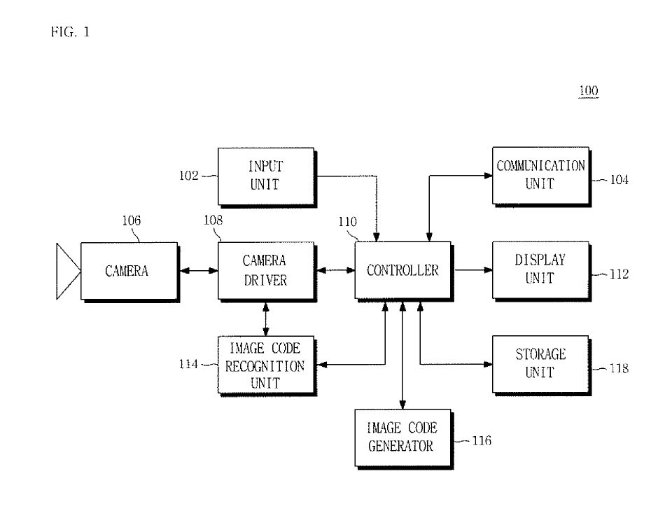

FIG. 1 is a block diagram showing the construction of a mobile terminal to which a login method using an image code is applied according to an embodiment of the present invention.

Referring to FIG. 1, the mobile terminal 100 includes an input unit 102, a communication unit 104, a camera 106, a camera driver 108, a controller 110, a display 112, an image code recognition unit 114, an image code generator 116 and a storage unit 118.

The input unit 102 receives an instruction regarding image code generation or image code recognition. The input unit 102 has a number of buttons necessary to manipulate the camera 104. The input unit 102 includes a plurality of alphabetical and numeric buttons for inputting an identification (ID), a password, a website address, and the like when an image code is generated.

The communication unit 104 transmits and receives voice signals for telephone calls, multimedia data, and the like, to and from other mobile terminals via a mobile communication network. To this end, the communication unit 104 includes a transceiver unit for transmitting and receiving a voice signal and data.

The camera 106 captures an image of an object and obtains an image signal. In particular, the camera 106 photographs an image code.

The camera driver 108 drives the camera 106 according to photographing control, and converts the image signal, received from the camera 106, into image data.

The controller 110 provides an input screen for allowing IDs, passwords, website addresses, and the like to be input through the display 112 when an image code generating instruction is input from the input unit 102. Furthermore, the controller 110 controls an image code to be generated through the image code generator 116. At this time, the controller 110 stores the generated image code in the storage unit 118.

If an instruction regarding image code recognition is input from the input unit 102, the controller 110 drives the camera driver 108 so that the camera 106 photographs the image code. The controller 110 controls the image code recognition unit 114 to interpret the photographed image code, and executes a login based on the ID and password included in the image code.

The display 112 displays an operating status of the mobile terminal 100. The display 112 also provides an input screen for prompting a user to input IDs, passwords, website addresses, and the like when generating an image code. The display 112 displays the image code thereon.

The image code recognition unit 114 interprets the photographed image code. Furthermore, the image code recognition unit 114 transmits contents of the interpreted image code, that is, an ID, a password, a website address, and the like to the controller 110. The image code recognition unit 114 may also be installed as an image-code agent in other types of terminals, such as computer or PDA (personal digital assistant), other than the mobile terminal.

The image code generator 116 generates an image code input by a user. The generated image code can be stored in the storage unit 118 or transmitted to other terminals via a wireless application protocol (WAP).

Meanwhile, in order to recognize the ID and password included in the image code of other terminals, the image-code agent will typically be installed at other terminals.

For example, when the other terminal is a computer, the image code agent can be installed in the computer. If the computer requires login on the initial screen or when the computer is booting or returning from a standby screen to a previous normal screen, a user lets the image code recognized by the computer through the image code agent. Accordingly, the computer can execute a login by recognizing an ID and password included in the image code through the image code agent.

The storage unit 118 stores the image code generated by the image code generator 116.

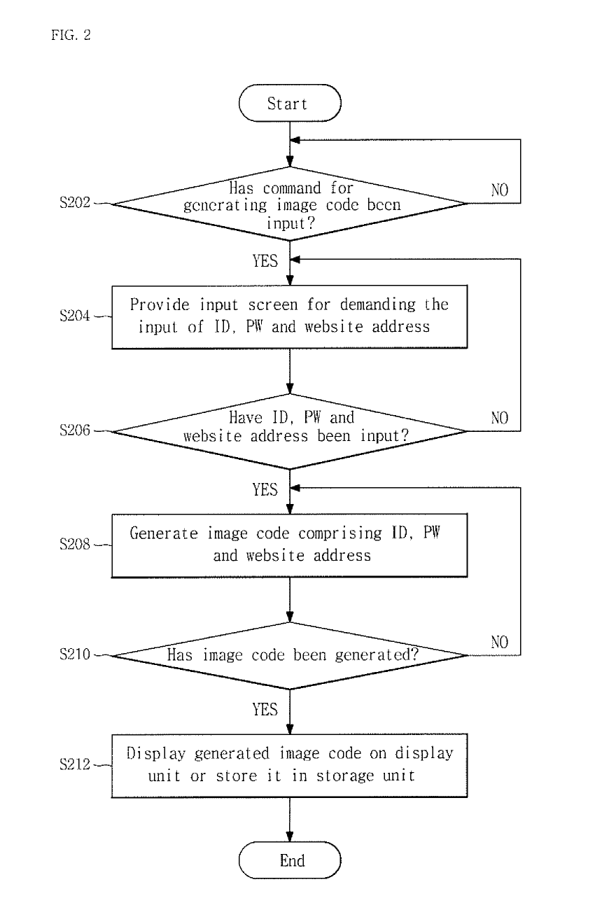

FIG. 2 is an operational flowchart illustrating a process of generating an image code during a login according to an embodiment of the present invention.

Referring to FIG. 2, a user selects an image code generating menu from a number of menus, which are provided by the mobile terminal 100, through the input unit 102. Then, it is determined whether the user has input a command for generating an image code through the input unit 102 (block S202).

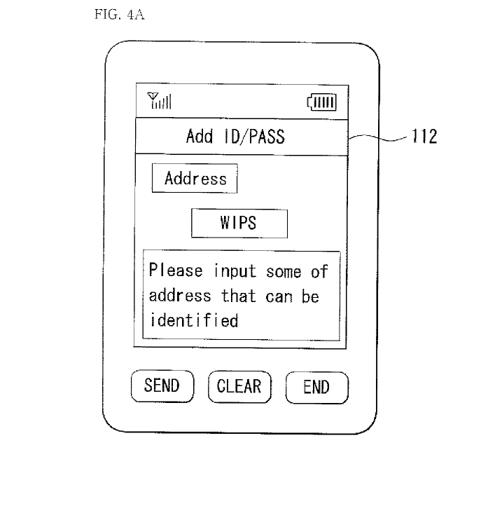

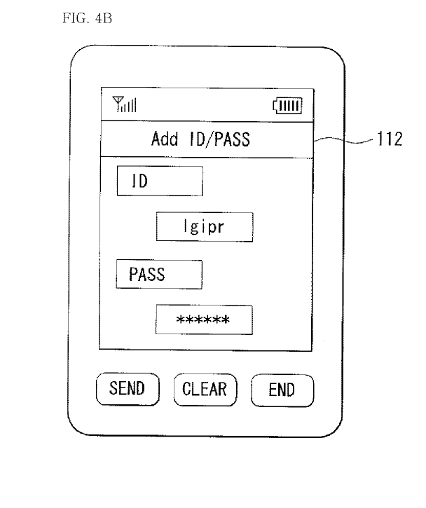

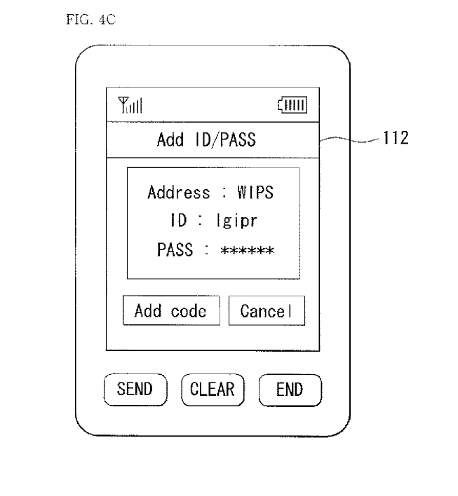

The controller 110 provides an input screen to be displayed on the display 112, as illustrated in FIG. 4A, for requesting input of an ID, a password, or a website address that the user desires to access according to the image code generating instruction of block S204.

The user reads the screen of the display 112 prompting the input of a website address, as illustrated in FIG. 4A, and inputs a website address through the input unit 102.

The controller 110 also controls an input screen to be displayed on the display 112 for prompting the user to input an ID and a password necessary for login to the desired website, as illustrated in FIG. 4B. The user inputs an ID, a password, and the like to access the website through the input unit 102 at block S206.

FIG. 4b illustrates a screen in which an ID and a password are input in the process of generating an image code.

The input screens illustrated in FIGS. 4A and 4B include input boxes for inputting an ID, a password, a website address and the like.

Further, the user can input an additional ID and password, as illustrated in FIG. 4C, after inputting the ID and password. Furthermore, the user can also input a number of additional IDs and passwords. FIG. 4C illustrates a screen in which an ID and password are added in the process of generating an image code.

If the website address, ID and password are input by the user through the input unit 102, the controller 110 controls the image code generator 116 to generate an image code including the website address, ID and password at block S208.

The format of the image code may include a barcode, QR (Quick Response) code, Data Matrix, PDF 417, Maxi Code, Color Code, Gray Code, 3-D barcode, and the like.

The format of the image code may also include a raster-based bitmap file, a vector-based metafile, and the like.

If it is determined that the image code has been generated, the controller 110 controls the generated image code to be displayed on the display 112, or controls the generated image code to be stored in the storage unit 118 (block S210, S212).

Furthermore, the controller 110 can communicate the image code, which is stored in the storage unit 118, to other mobile terminals or other types of terminals on which the image code can be displayed through USB (universal serial bus) or UART (universal asynchronous receiver/transmitter).

The image code generated in the mobile terminal 100 can be transmitted to other terminals in order to store it in storage media of other terminals, and may also be printed on a name card frequently used by a user.

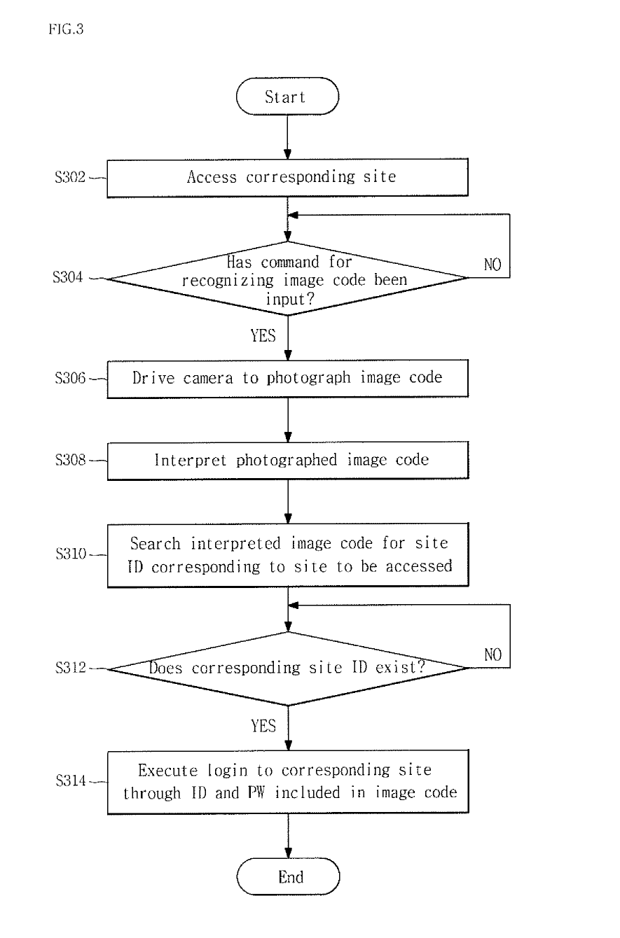

FIG. 3 is an operational flowchart illustrating a process of recognizing an image code using an image code according to an embodiment of the present invention.

Referring to FIG. 3, the mobile terminal 100 accesses a website at block S302.

Accordingly, the site, which a user wants to access, may request login information from the user, prompting the user to input an ID and a password.

Meanwhile, the terminal may request the user to log in on the initial screen such as Windows screen, or when the terminal is booting or returning from a standby screen to a previous normal screen.

In order to log in, the user selects an image code recognition menu from a number of menus through the input unit 102 of the mobile terminal 100. Then, a command for recognizing image code is input through the input unit 102 at block S304.

The controller 110 controls the camera driver 108 to drive the camera 106 based on the image code recognition instruction, and also controls the camera 106 to photograph an image code at block S306.

The target image code may be an image code printed on a user's name card, or an image code displayed on a terminal.

The image code photographed by the camera 106 is converted into image data through the camera driver 108.

The controller 110 controls the image code recognition unit 114 to analyze and interpret the photographed image code at block S308.

The controller 110 then searches the interpreted image code for a site ID corresponding to a site to be accessed at block S310.

If it is determined that a corresponding site ID exists in the searched image code at block S312, the controller 110 reads an ID and a password corresponding to a corresponding site ID from the image code, and executes login to access the corresponding site based on the ID and password at block S314.

In this case, if a terminal recognizing the image code is a different type of terminal, such as computer, but not mobile terminal, the image code recognition unit 114 may be an image code agent installed in the computer. The computer recognizes an ID and a password, which are included in the image code, through the image code agent, and executes login.

As described above, at least one implementation of the present invention is configured to enable login execution using an image code to be recognized anytime and anywhere.

As described above, the image code may be generated to be used when logging in to a computer or a mobile terminal. Furthermore, the image code may be used to log in to a computer or to access a website.

The foregoing embodiments and advantages are merely exemplary and are not to be construed as limiting the present invention. The present teaching can be readily applied to other types of apparatuses and processes. The description of the present invention is intended to be illustrative, and not to limit the scope of the claims. Many alternatives, modifications, and variations will be apparent to those skilled in the art.

What is claimed is:

1. A method of generating an image code, the method comprising:
receiving a site identification (ID) of an access site;
receiving a user ID and a password for accessing the access site; and
generating an image code for establishing a login to the access site based upon the user ID and the password.

2. The method of claim 1, wherein the image code comprises one or more pieces of information relating to the access site.

3. The method of claim 1, wherein the site ID of the access site comprises a portion or all of a website address.

4. The method of claim 1, wherein the login comprises a login through an initial screen and a login when booting an operating system.

5. The method of claim 1, wherein the login comprises a login when returning from a standby screen to a previous user screen.

6. A method for performing login using an image code, the method comprising:
connecting to a site to which access requires a login;
obtaining an image code via a camera;
obtaining information from the image code;
identifying in the information a site identification (ID) corresponding to the site; and
initiating a login to the site based on a user ID and password included in the image code and which correspond to the site ID.

7. The method of claim 6, wherein the image code comprises one or more pieces of information relating to the access site.

8. The method of claim 6, wherein the login comprises a login through an initial screen.

9. The method of claim 6, wherein the login comprises a login when booting an operating system and a login when a terminal returns from a standby screen to a previous user screen.

10. The method of claim 9, wherein the login comprises a login through an image code agent installed in a terminal.

11. The method of claim 6, wherein the site ID comprises a portion or all of a website address.

12. A terminal for login using an image code, the terminal comprising:
an image code generator for generating an image code for a login;
an image code recognition device for obtaining information from the image code; and
a controller for identifying in the information a site identification (ID) corresponding to a site, and if the site ID is identified, initiating a login to the site based on a user ID and password included in the image code and which correspond to the site ID.

13. The terminal of claim 12, wherein the site ID comprises a portion or all of a website address.

14. The terminal of claim 12, wherein the login comprises a login through an initial screen.

15. The terminal of claim 12, wherein the login comprises a login when booting an operation system and a login when returning from a standby screen to a previous user screen.

16. A terminal for generating an image code, the terminal comprising:
means for receiving a site ID of an access site;
means for receiving a user identification (ID) and a password for accessing the access site; and
means for generating an image code for establishing a login to the access site based upon the user ID and the password.

17. The terminal of claim 16, wherein the image code comprises one or more pieces of information relating to the access site.

18. The terminal of claim 16, wherein the site ID of the access site comprises a portion or all of a website address.

19. The terminal of claim 16, wherein the login comprises a login through an initial screen and a login when booting an operating system.

20. The terminal of claim 16, wherein the login comprises a login when returning from a standby screen to a previous user screen.
